(19) United States
(12) Patent Application Publication
(10) Pub. No.: US 2005/0180006 A1
(43) Pub. Date: Aug. 18, 2005

(54) Curved wide angle 3-D picture

(76) Inventor: Roberto Vallarta Mendoza, Citrus Hts, CA (US)

Correspondence Address: Roberto Vallarta Mendoza, 6355 Cheltenham Way, Citrus Hts., CA, 95621, US

(21) Appl. No.: 11/038,646

(22) Filed: Jan. 18, 2005

Related U.S. Application Data
(60) Provisional application No. 60/539,319, filed on Jan. 22, 2004.

(51) Int. Cl. G02B 27/22; G02B 27/10

(52) U.S. Cl. 359/463; 359/619

(57) ABSTRACT

The present invention relates to the production of three dimensional images using lenticular imaging and/or integral imaging methods for a curved 3-D image with curved lenticular sheet and/or a curved 3-D image with a curved fly-eye lens array. A lenticular image or an integral imaged is bent into a curve, with the image being on the inside of the curve. A lenticular image need only be curved horizontally. An integral image is preferably curved both horizontally and vertically. It can also be curved just horizontally. Depending on the quality of the lenticular sheet, “ghosting” is minimized or eliminated altogether. For a lenticular image, bending the image horizontally will produce a wide-angled view of the whole image. For an integral image, bending the image in the horizontal view will produce a wide horizontal angle for the image. “Ghosting” is minimized or eliminated altogether for the horizontal direction. If the integral image is curved both horizontally and vertically, a wide-angled view of the whole image is obtained and “ghosting” is minimized or eliminated altogether for the whole image.

### CROSS REFERENCE TO RELATED APPLICATIONS

U.S. Patent Documents

| | | |
|---|---|---|
| 4825234 | April, 1989 | Cai |
| 5365294 | November, 1994 | Anderson |
| 6251566 | June, 2001 | Brosh, et al |
| 6683725 | January, 2004 | Wohlstadter |
| 6721101 | April, 2004 | Daniell |
| 6806851 | October, 2004 | Shimoyama, et al |
| 6813083 | Noverber, 2004 | Kobayashi |

U.S. Provisional Applications

| | | |
|---|---|---|
| 60/539319 | Jan. 22, 2004 | Mendoza |

### BACKGROUND

The use of lenticular sheets and fly-eye arrays to produce 3 D images is well known. Lenticular sheets made of parallel vertical rows of cylindrical lenticular lenses or lenticules can be made to produce 3 D images with horizontal parallax. A more common use for lenticular sheets is to produce auto-stereoscopic 3 D images where the lenticular sheet is used to direct separate images of the same scene/object to the right and left eye. Fly-eye arrays consists of an array of very small lenses, otherwise called lenslets or fly-eye lenses. Fly-eye arrays can be made to produce 3 D images with both horizontal and vertical parallax. Lenticular sheets in particular are commonly used with the production of stereo-images. These are images that depend on their 3-D effect by presenting a separate image for each eye of the person viewing the 3-D image. Those two separate images are sometimes referred to as a stereoscopic pair.

Various shortcomings of both lenticular sheets and fly-eye arrays are also well known. It is discussed in U.S. Pat. No. 6,721,101, U.S. Pat. No. 6,813,083, and U.S. Pat. No. 6,806,851. However, one shortcoming not often discussed has to do with limitations in the optics of both lenticules and fly-eye lenses. This has to do with the viewing angles of the lenses. Basically, all manufactured lenses have some limits to their viewing angle. For lenticules and fly-eye lenses, this means that if an image is placed behind them, the lenticule or fly-eye lens cannot project that image beyond the viewing angle. This problem can be illustrated in FIG. 15 of Drawings in this document, where the set point in space is outside the viewing angle. This set point can be where a person's eye is located. If a person's eye is not in located within the viewing angle, then that eye cannot see the image through the lenticules or fly-eye lenses. In practical terms, this means that if one were viewing a 3 D image through a lenticular sheet or a fly-eye lens array, those parts of the 3 D images that are not directly in front of the person viewing the image will have more distortion. The further off sideways the image is, the more pronounced the distortion. In particular, for images that are too far off to the sides, said images that are placed behind a particular lenticule or behind a particular lenslet or fly-eye lens will be viewed by said person through through other lenticules or through other lenslet or fly-eye lens, not through that particular lenticular or that particular lenslet or fly-eye lens. This effect is known as “ghosting”.

“Ghosting” is the common term used for 3-D images when the person viewing the 3-D image views an unwanted image. Some of the methods used to minimize the effect of “ghosting” in the production of large stereo-images involve placing the stereoscopic pair in close proximity to each other. However, since the perception of distance in stereo-images depends on how far off the stereoscopic pair are from each other, this limits the perception of depth in the 3-D image.

Hereafter, in this document, lenticular images will refer to images made using lenticular sheets. Integral images will refer to images made using fly-eye lens arrays.

### SUMMARY OF THE INVENTION

The problem of overcoming the limited viewing angle of the lenticules in the lenticular sheet or the lenslet/fly-eye lens in the fly-eye array can be eliminated by the simple method of bending the image into a curve. FIGS. 15 and 16 of the Drawings in this document illustrates how the problem is solved. In both figures, the set point in space can be where a person's eye is located. In FIG. 15, this set point is outside the viewing angle, thus the set point cannot receive the image from the lenticule/fly-eye lens. However, if the lenticule/fly-eye lens is rotated just the right way, this set point is brought within the viewing angle and now, this set point can receive images from the lenticule/fly-eye lens.

For lenticular images, the effect of rotating each lenticule in a lenticular sheet can be imitated by bending the lenticular sheet into a curved shape, with the image curving in the horizontal direction, and such that the lenticules are located on the inside of the curve. This is illustrated in FIGS. 1, 2, 3, 4, and 5 of the Drawings in this document. The shape of a cylindrical section would be ideal in this case. Referring to FIGS. 1, 2, and 3, if a person's eyes is located near the image focal line, with the line running between said person's eyes, then both eyes can be brought into the viewing angle of every lenticule in the lenticular sheet used for the 3-D image.

For integral images, the method of bending the image such that the image has a curve in the horizontal direction will solve the problem of limited viewing angle in the horizontal direction. However, since a lenslet or fly-eye lens also has a limited viewing angle in the vertical direction, to solve the problem of the limited viewing angle will require that the image also be curved in the vertical direction. This is illustrated in FIGS. 12, 13, and 14 of the Drawings in this document. Here, the image has been curved into a saucer-like shape. Note that the important point is that images curves both horizontally and vertically. Referring to FIGS. 12, 13, and 14, if a person's eyes are located near the image focal point, with the point located between the person's eyes, then, that person's eyes can be brought within the viewing angle of every lenslet/fly-eye lens in the fly-eye lens array used in the 3-D image.

Depending on the quality of the lenticular sheet, “ghosting” is minimized or eliminated altogether. For a lenticular image, bending the image horizontally will produce a wide-angled view of the whole image. For an integral image, bending the image in the horizontal view will produce a wide horizontal angle for the image. “Ghosting” is minimized or eliminated altogether for the horizontal direction. If the integral image is curved both horizontally and vertically, a wide-angled view of the whole image is obtained and “ghosting” is minimized or eliminated altogether for the whole image.

### BRIEF DESCRIPTION OF THE DRAWINGS

FIG. 1 is side view of a curved three dimensional picture of the present invention in its first embodiment.

FIG. 2 is a front view of the curved 3 D picture of FIG. 1.

FIG. 3 is a view of the curved 3 D picture of FIG. 1 as seen from a third angle.

FIG. 4 is a partial view of a horizontal cross section of the curved 3 D picture of FIG. 1 illustrating the lenticular film strips through the lenticular lens.

FIG. 5 is a view of a horizontal cross section of the curved 3 D picture of FIG. 1.

FIG. 6 is a side view of a curved three dimensional picture of the present invention in its second embodiment.

FIG. 7 is a front view of the curved 3 D picture of FIG. 6.

FIG. 8 a view of the curved 3 D picture of FIG. 6 as seen from a third angle.

FIG. 9 is a partial view of the surface of the 3 D picture of FIG. 6 illustrating the integral film spots through the lenslets or fly-eye lens.

FIG. 10 is a partial view of a horizontal cross section of the curved 3 D picture of FIG. 6 illustrating the integral film spots through the lenticules of fly-eye lens.

FIG. 11 is a view of a horizontal cross section of the curved 3 D picture of FIG. 6.

FIG. 12 is a side view of a curved three dimensional picture of the present invention in its third embodiment.

FIG. 13 is a front view of the curved 3 D picture of FIG. 10.

FIG. 14 is a view of the curved 3 D picture of FIG. 10 as seen from a third angle.

FIG. 15 is a view of a lenticule or fly-eye lens.

FIG. 16 is a view of the same lenticule or fly-eye lens that has been rotated.

### DETAILED DESCRIPTION OF THE DRAWINGS

The numbers in the figures are defined in the following way; picture 20, image focal line 25, vertical line 30, section 35, viewing surface 40, lenticular sheet 50, lenticulars 55, surface 58, areas 60, area of convergence 63, dashed lines 58, point 65, fly-eye lens array 85, lenslets 75 or fly-eye lens 75, integral image spot 70, area 82, dashed lines 79, image focal point 84, fly-eye lens array 85, fly-eye lens array 90, lenslets 98 or fly-eye lens 98, image 93, solid viewing angle 100, image focal point 95, lenticule 115, viewing angle 125, dashed lines 130, set point 120.

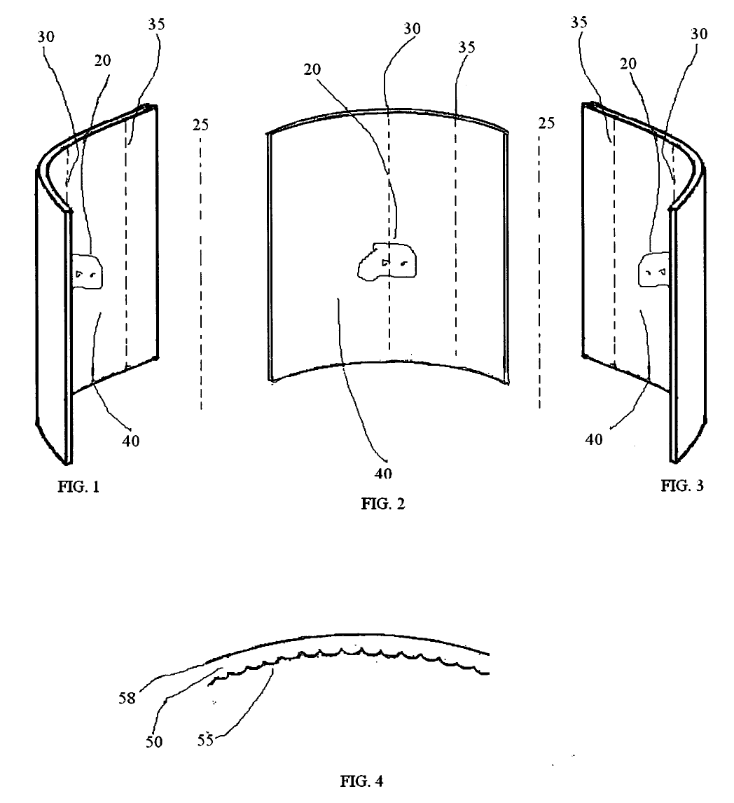

Referring to the Drawings, FIGS. 1, 2, 3, 6, 7, and 8 shows a three dimensional picture 20 as the picture is rotated. The picture 20 is rotated such that it can be viewed through a variety of angles. As the picture 20 rotates, various perspectives of the three dimensional picture is seen. The curved viewing surface is in the shape of a planar curve such as a cylindrical section. This means that the further the distance of a section 35 of the viewing surface 40 is from the vertical line 30, the more the section 35 is bent inwards.

Referring to FIGS. 1, 2, and 3, the picture 20 can only be assured of being viewed in its proper form if the person viewing sees the front view FIG. 2 of the 3 D picture and only if the person viewing is located around the image focal line 25. The surface consists of a lenticular sheet 50.

Referring to FIG. 4, the inside surface of the curved viewing surface is a lenticular sheet 50 formed of a plurality of individual, vertically extending, parallel lenticulars 55 defining a first lenticulated surface and a second smooth surface 58 below the lentculated surface. The picture 20 will be printed on top of the smooth surface 58 and below the lenticulated surface.

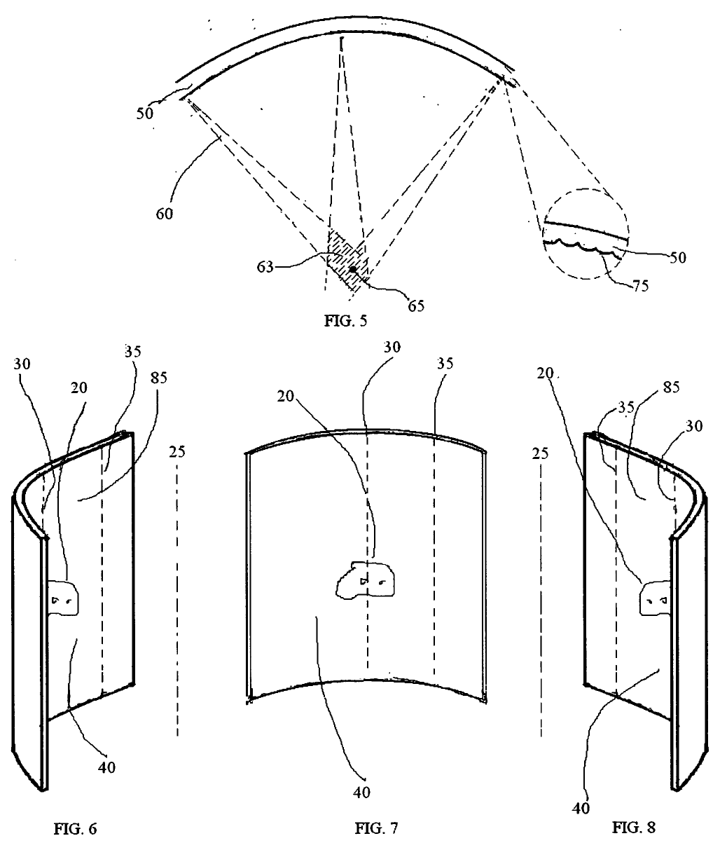

Referring to FIG. 5, the areas 60 between the dashed lines 58 from the surface of the lenticular sheet 50 represent the viewing angle of an individual lenticule 75 (exploded view) in the lenticular sheet 50. The point 65 represents a set distance from the lenticular sheet. Point 65 is withing the viewing angle of every lenticule 75 (exploded view) in the lenticular sheet 50. If the curved viewing surface is in the shape of a cylindrical surface, point 65 will be equidistant from every lenticule 75 (exploded view) in the lenticular sheet 50. The point 65 is the area around which the person viewing the 3 D picture must position himself/herself for optimal viewing of the 3 D picture. Also, the point 65 is a point located in the focal line 25 in FIGS. 1 and 3. The area of convergence 63 represents the area in space where the viewing angles of the lenticules in said horizontal cross section converge.

Referring to FIGS. 6, 7, and 8, the surface consists of a fly-eye lens array 85, with the viewing surface 40.

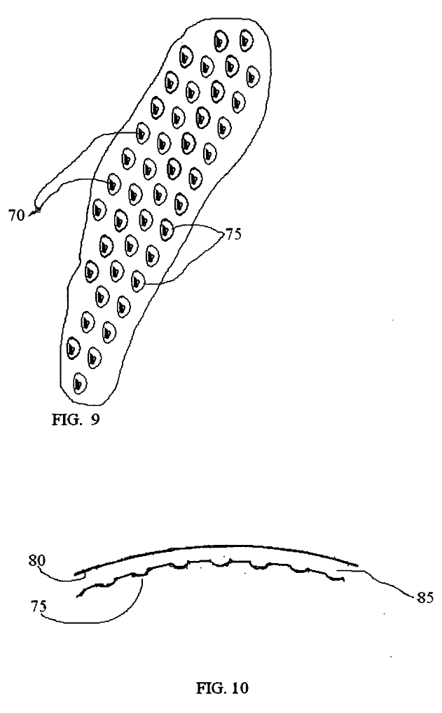

Referring to FIGS. 9 and 10, a fly-eye lens array 85 of lenslets 75 or fly-eye lens 75 covers the viewing surface. Below each lenslet 75 or fly-eye lens 75 is an integral image spot 70. Each integral image spot offers a picture of the same scene or object from a slightly different perspective.

Referring to FIG. 11, the area 82 between the dashed lines 79 represents the viewing angle of the lenslet or fly-eye lens 75 (exploded view) in the fly-eye lens array 85. The image focal point 84 represents a set distance from the fly-eye lens array 85 and is within the viewing angle of each lenslet or fly-eye lens 75 (exploded view) contained in the horizontal cross section of the fly-eye array 85.

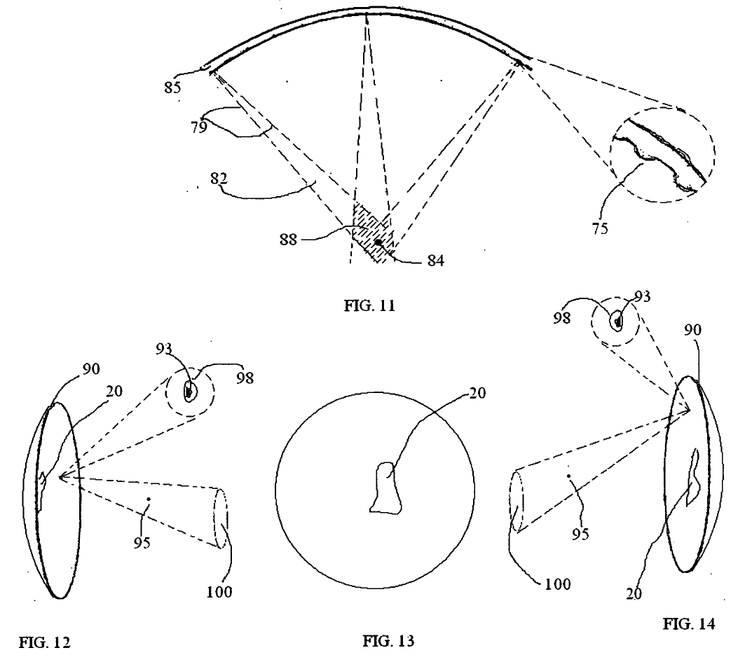

Referring to FIGS. 12, 13, and 14, shows a three dimensional picture 20 as the picture is rotated. A fly-eye lens array 90 consisting of horizontal and vertical arrays of lenslets 98 or fly-eye lens 98 is curved into a saucer-like shape. An image focal point 95 is set at a certain distance from the fly-eye lens array 90. Each lenslet 98 or fly-eye lens 98 has an image 93 located behind it. The fly-eye lens array 90 is curved or bent in such a way that the image focal point 95 is within the solid viewing angle 100 of each and every lenslet 98 or fly-eye lens 98 in the fly-eye lens array 90. If the fly-eye lens array 98 is shaped like a section of a sphere, then the focal point 95 is equidistant to each and every lenslet 98 or fly-eye lens 98 in the fly-eye lens array 90.

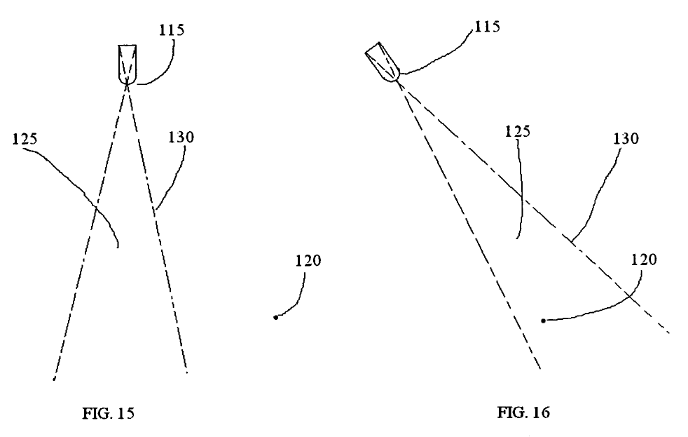

Referring to FIG. 15, a lenticule 115 or a fly-eye lens 115 is shown with the viewing angle 125 shown between the dashed lines 130. A set point 120 in space is also shown.

Referring to FIG. 16, the same lenticule has now been rotated counter-clockwise.

### DESCRIPTION

The curved wide angle 3-D picture overcomes the limitations inherent in the optics of the lenticules used in lenticular sheets and the limitations inherent in the optics of the lenslets or fly-eye lens used in lenticular sheets for integral photography by bending the three dimensional image into a curved shape.

In the first embodiment of the present invention, the three dimensional image shall be shaped approximate like a cylindrical section. The three dimensional image shall consist of a series of image strips placed behind a lenticular sheet consisting of parallel vertical rows of lenticules. There will be a lenticule in front of each image strip. The three dimensional image is curved horizontally. The three dimensional image begins to curve on both sides of and from an imaginary vertical line set in the midst of the three-dimensional image. The further the distance of a point in the three dimensional image from said imaginary vertical line, the more pronounced the curve. The curve can be of any shape, limited only by the requirement that an image focal line at a certain set distance from the three dimensional image be within the viewing angle of every lenticule in the lenticular sheet. We further require that points in the three dimensional image that are at the same distance from the imaginary vertical line in the midst of the three dimensional image be bent or curved by the same amount. The shape defined by a planar section of a cylinder would be ideal in the sense that the distance between a lenticule and the image focal line is the same for each and every lenticule in the lenticular sheet. Thus, this line defining the set distance would be at the center of the viewing angle of each and every lenticule in the lenticular sheet. Referring to FIG. 5, we will henceforth refer to the collection of all the areas of convergence in said lenticular image, denoted by 62 in FIG. 5 as the volume of convertence.

For the first embodiment of the present invention, the person engaged in viewing shall position the three dimensional image such that the person's eye's is within the volume of convergence, in the immediate vicinity of the image focal line. The eyes of the person engaged in viewing should thus be in the viewing angle of every lenticule in the lenticular sheet. In this manner, said person should obtain a clear view of the entire three dimensional image, with the exception of those parts of the three dimensional image that is outside said person's field of vision.

In the second embodiment of the present invention, the three dimensional image is also shaped approximately like a cylindrical section. The three dimensional image consists of an array of micro-images placed behind a lenticular sheet made up of an array of lenslets or fly-eye lenses. There will be a lenslet or fly-eye lenses in front of each micro-image. As in the first embodiment of the present invention, the three dimensional image is curved horizontally. However, since the viewing angle of each lenslet or fly-eye lens is a solid angle, the requirement of the curve of the three-dimensional image is that for every lenslet or fly-eye lens within a horizontal cross section, then for a point that is level with said horizontal cross section and located in the image focal line, said point should be within the viewing angle of each lenslet or fly-eye lens in the said horizontal cross section. As in the first embodiment of the first invention, we require that points in the three dimensional image that are at the same distance of an imaginary vertical line in the midst of the three dimensional image be bent or curved by the same amount.

For the second embodiment of the present invention, the person engaged in viewing should position the three dimensional image in such a manner that the eyes of the person engaged in viewing is in the immediate vicinity of the focal line of the image. This would result in the eyes of said person being within the viewing angle of the lenslets or fly-eye lenses in the fly-eye lens array if the lenslet or fly-eye lens is level or somewhat level with the eyes of the person doing the viewing. Thus, said person should obtain a clear view of those parts of the three dimensional image that is lever or somewhat level with the eyes of said person except for those parts of the three dimensional image that is outside of said person's field of vision.

In the third embodiment of the present invention, the three dimensional image shall have a saucer-like shape. The three dimensional image shall consists of an array of micro-images placed behind a lenticular sheet made up of an array of lenslets or fly-eye lenses, otherwise called a fly-eye lens array. The three dimensional image shall be curved both horizontally and vertically. The three dimensional image shall begin to be curved from a point in the midst of the three dimensional image. We further require that the three dimensional image shall be curved in such a way that the image focal point shall be within the solid viewing angle of each and every lenslet or fly-eye lens in the three dimensional image. A shape defining the section of a sphere is ideal in that the focal point of the image is set a the same distance for each and every lenslet or fly-eye lens in the fly-eye lens array. Thus, image focal point is in the middle of the solid viewing angle of each and every lenslet or fly-eye lens in the flye-eye lens array. For the third embodiment of the present invention, any reference to a volume of convergence will refer to a volume set in space where the viewing angles of two or more lenslets or fly-eye lens converge.

For the third embodiment of the present invention, the person engaged in viewing should position the three dimensional image in such a manner that the eyes of said person are both within the volume of convergence of all the lenslets or fly-eye lens in said integral image, in the immediate vicinity of the image focal point. This should result in the eyes of said person being located within the solid viewing angle of each and every lenslet or fly-eye lens in the fly-eye lens array. Thus, said person should obtain a clear view of the whole three dimensional image, with the exception of those parts of the three dimensional image that is outside said person's field of vision.

1. A lenticular image formed in that said lenticlar image is curved in the horizontal direction and said lenticular image being located on the inside surface that follows said horizontal curve.

2. The lenticular image according to claim 1 in that the lenticular sheet used in said lenticular image is located on the inside of the curved surface.

3. The lenticular image according to claims 1 and 2 in that the front of said lenticlar sheet faces away from the surface of said curved surface.

4. The lenticular image according to claims 1, 2, and 3 in that said lenticular image has the shape of a cylindrical section.

5. The lenticular image according to claim 1 in that the shape of the lenticular image is such that the viewing angle of all the lenticules in said lenticular image will all converge upon a common line located in space.

6. The lenticular image according to claims 1 and 5 in that for a strip of surface located along said line and within the volume of convergence, said strip being at a minimum the width of the inter-ocular distance of a person's eyes, the shape of said lenticular image is such that the viewing angles of said lenticules will meet the front surface of said strip before the back surface of said strip.

7. An integral image formed in that said integral image is curved in the horizontal direction and said integral image being located on the inside surface that follows said horizontal curve.

8. The integral image according to claim 7 in that the fly-eye lens array used in said integral image is located on the inside of the curved surface.

9. The integral image according to claims 7 and 8 in that the front of said integral sheet faces away from the surface of said curved surface.

10. The integral image according to claims 7, 8 and 9 in that said integral image has the shape of a cylindrical section.

11. An integral image according to claim 7 in that the shape of the curve of said integral image is such that for any horizontal section of said integral image, the viewing angle of all the lenslet or fly-eye lens in said integral image will all converge upon a point in said horizontal direction.

12. An integral image according to claims 7 and 11 in that for a line containing the width of the area of convergence, said line being at a minimum the length of the inter-ocular distance of a person's eyes, the shape of the curve of said integral image is such that the viewing angle of said lenslet or fly-eye lens will cross the side of said line facing said integral image before crossing the side of said line facing away from said integral image.

13. An integral image according to claims 7, 11, and 12 in that the collection of all said points will form a straight line.

14. An integral image formed in that said integral image is curved in both the horizontal and vertical direction.

15. An integral image according to claim 14 in that the fly-eye lens array used for said integral image is located on the inside surface of said curves.

16. An integral image according to claims 14 and 15 in that said fly-eye lens array faces away from the surface of said inside surface.

17. An integral image according to claims 14, 15, and 16 in that said integral image has the shape of a spherical section.

18. An integral image according to claim 14 in that the shape of said integral image is such that the solid viewing angles of all the lenslets or fly-eye lens used in said integral image will converge upon a point in space.

19. An integral image according to claims 14 and 18 in that within the volume of said convergence, there is a cross section that is at a minimum the width of the inter-ocular distance of a person's eyes, the shape of said integral image is such that the solid viewing angles of all said lenslets or fly-eye lens will cross the side of said cross section that faces said integral image before crossing the side of said cross section that faces away from said integral image.
